(19) United States
(12) Patent Application Publication
(10) Pub. No.: US 2004/0224072 A1
(43) Pub. Date: Nov. 11, 2004

(54) Soft frozen puree composition

(76) Inventors: Abizer Khairullah, Morgan Hill, CA (US); Forrest Griesbaum, Gilroy, CA (US); Jane Dong, Gilroy, CA (US); Sambasiva R. Chigurupati, Omaha, NE (US); Maria S. Alviar-Agnew, Davis, CA (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/434,658

(22) Filed: May 9, 2003

(51) Int. Cl. A23K 1/00

(52) U.S. Cl. 426/615

(57) ABSTRACT

The present invention relates to a method for forming a soft frozen puree, whereby the method includes the use of carbohydrate water binders.

### FIELD OF INVENTION

The present invention relates to a puree or particulate composition formed from plant materials, such as vegetables, fruits, and herbs, and an amount of carbohydrate water binder, preferably inulin. Once formed, the puree or particulate composition is frozen, with the resultant product of a constitution that it can be scooped readily in its frozen state.

### BACKGROUND OF INVENTION

Soft frozen puree or particulate compositions are widely used in industrial food applications as natural flavorants to a wide variety of food applications. In particular, these purée or particulate compositions are used as convenient substitutes in place of fresh purées and chopped plant material, such as vegetables, herbs, or fruits. The resultant puréed or particulate products are readily used in food applications, such as sauces, dressings, spreads, salsas, toppings, and soups.

While widely used, the known purée or particulate compositions suffer from a few problems. In particular, it is known that most constituents used to form the purée or particulate composition result in a product having a sweet taste that does not always represent the natural flavor of the original material. As such, it is desired to have a composition and method whereby the flavor impact on the purée or particulate composition is minimized.

Cold swelling starches have been known to be used in formation of the purées or particulates. These starches form a product that is “gummy” and, therefore, does not resemble the consistency of the original vegetable material. Precooked or pregelatinized rice flours also tend to produce gummy or thickened purées immediately after mixing. The addition of natural or synthetic gums, such as xanthan, guar, locust bean, carrageenan, alginate, methylcellulose, and the like, in purées could also make the resulting mixture gummy. Gummy products are those that bind together and do not readily blend into a mixture. It is desired to have a purée that is free from lumps or that does not congeal or gum during heating.

The use of sugar combinations in puréed products has also been known. Typically, at least 50% of the sugar portion has been dextrose plus fructose. This combination prevents crystallization during freezing. Unfortunately, dextrose and fructose cause the finished product to be sweet. For this reason, it is desired to have a composition that does not readily crystallize when frozen, and does not contribute an overly sweet taste. Further, dextrose and fructose are reducing saccharides that are prone to undergo Maillard-type reactions. Thus, the presence of these sugars in a food composition will result to undesirable browning during heating or storage.

Low molecular weight sugar syrups have been used in known purées, with the sugars considered an advantage because they prevented crystallization. For example, the addition of high fructose corn syrup into a vegetable purée results in a product that is soft frozen. The resultant product, however, undergoes syneresis upon storage abuse (thawing). Syneresis relates to the bleeding or leaking of water from the thawed product. It is desired to have a product that overcomes that limitation by binding the free water, whereby expelled water is prevented or limited.

Thus, it is desired to have a product that lends its own natural flavor, and has very little to no sweetness and, therefore, can be used in food applications where added sweetness is undesirable. It is also desired to have a product that does not contain added fructose plus dextrose and, therefore, will not undergo Maillard-type browning reactions during heating and storage.

### SUMMARY OF INVENTION

The present invention relates to a soft frozen purée composition, formed from plant material and a carbohydrate water binder, and methods for making the purée composition. The resultant purée composition can be used immediately after removal from a freezer. Consequently, the product of this invention is similar to its fresh counterpart, and can be used as a natural flavorant in a wide variety of food applications, such as sauces, dressings, spreads, salsas, toppings, and soups.

The soft frozen purée composition will contain an amount of plant material ranging between 60% and 90% by weight of the purée composition. Any of a variety of plant materials may be used. The carbohydrate water binder is added in an amount ranging between 5% and 25% by weight of the purée composition. The preferred carbohydrate water binder is inulin. Any water binder that binds water, decreases syneresis, doesn't cause to the final product to readily crystallize, and can be used in an amount that doesn't overly sweeten the composition can be used.

The soft frozen purée can be a purée or a particulate composition (it will be referred to as a purée throughout). As such, plant materials of a variety of sizes may be used. Optionally, a second carbohydrate water binder can be added in an amount ranging between 5% and 25% by weight of the purée. Salt can be optionally added in an amount ranging between 0.1% and 10% by weight of the purée. Further, a third carbohydrate water binder added in an amount ranging between 0.1% and 10% by weight of the purée.

The method for forming the soft frozen purée is initiated by washing and sorting the plant material to remove foreign materials, as well as molded, bruised, and defective pieces. The plant material is then preferably blanched (by water or steam) to reduce the microbial load. The blanched material is cooled to minimize cooking of the outer surface, followed by puréeing an amount of plant material to form plant purée. The purée can be of a variety of sizes. An amount of carbohydrate water binder is mixed with the plant purée to form the soft purée. The soft purée is frozen.

Importantly, the composition retains key flavor components, and has a desired flavor and color. Also, the product has a comparatively reduced sweetness. As such, the resultant product is well suited for use in a variety of products. There is limited crystallization in the product during freezing which allows the product to be readily scooped. Additionally, the resultant product does not undergo Maillard-type reactions during heating and storage. Finally, the product has limited syneresis during thawing.

### BRIEF DESCRIPTION OF DRAWINGS

FIG. 1 is a flow chart showing the steps of formation for the present method.

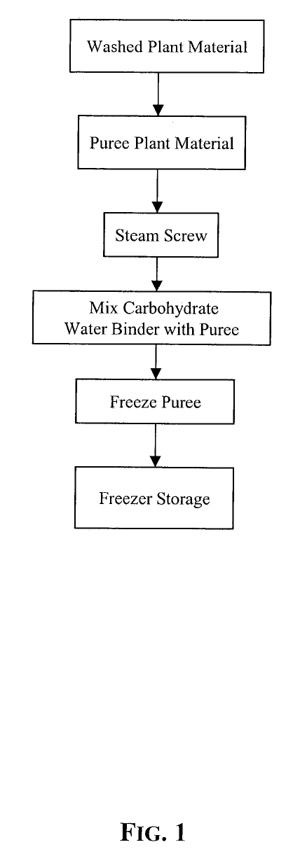

### DETAILED DESCRIPTION

The present invention relates to a soft frozen purée or particulate composition and methods for making the composition. The composition has a natural, fresh flavor similar to a fresh vegetable purée, but is frozen and scoopable. There is limited crystallization in the product during freezing which allows the product to be readily scooped. Additionally, the resultant product does not undergo Maillard-type reactions during heating and storage. Finally, the product has limited syneresis during thawing. Consequently, the product of this invention is similar to its fresh counterpart, and can be used as a natural flavorant in a wide variety of food applications, such as sauces, dressings, spreads, salsas, toppings, and soups. The product can also be used in any food application where piece identity is required.

The process for making the soft frozen purée or particulate composition is initiated by obtaining an amount of plant material. Any of a variety of different plant materials may be used, including vegetables, fruits, herbs, spices, and combinations thereof. Essentially, any plant material used as a natural flavorant in a food application can be formed into the soft frozen purée composition. Available vegetables include, but are not limited to, garlic, onion, jalapeno peppers, red bell peppers, green bell peppers, mushrooms, and celery. Available fruits include tomatoes, berries, and stone fruits. Various herbs and spices that may be used include basil, cilantro, ginger, thyme, and rosemary.

The plant material is preferably washed and carefully sorted to remove foreign materials as well as molded, bruised, and defective pieces. The material may then undergo a blanching treatment (preferably steam) long enough to reduce the microbial count. An immediate cooling step follows so as not to cook the outer surface of the material. An additional heating step such as roasting, sauteing, frying, grilling and the like can also be added if an additional flavor note (e.g. roasted, sauteed, fried, grilled) is desired. The roasting step is performed if a roasted-type of purée is desired.

Optionally, the plant material can be flavored with herbs or spices prior to use with the present invention. The plant material can be already chopped, ground, or puréed, or can be obtained in a natural, whole, unaltered form. If the plant material has not been altered, then it is likely necessary to chop, dice, or purée the plant material. Dependent upon the desired final use of the material, the final particle size will be determined. The resultant size and structure of the materials is dependent upon the desired end use. As such, the plant material can have a size ranging between puréed and whole, unaltered vegetable material. Any amount of material can be used, as this process can be used as part of a batch or a continuous product. The amount selected is dependent upon the amount desired for finished uses and the available equipment. Again, whether the plant material is chopped or puréed, it is referred to throughout as a purée.

After selection of the plant material and processing, if necessary, the next step includes adding an amount of carbohydrate water binder. The term carbohydrate water binder as used in this invention refers to carbohydrates which interact with water through permanent chemical linkages or temporary physical interactions. Any of a variety of carbohydrates with hygroscopic properties may be used, as long as the resultant purée or particulate composition can be frozen, has a flavor similar to a fresh puréed product, and can be scooped for use in a recipe. Additionally, there should be limited syneresis upon thawing and limited Maillard-type reactions during heating and storage. Any of a variety of carbohydrates may be used, including inulin, fructans, disaccharides, oligosaccharides, native starch, unmodified flour, starch hydrolysis products, polyhydric alcohols, and combinations thereof. It is most preferred to use inulin, either alone or in combination with the other carbohydrate water binders.

Inulin is a fructan group member. Fructans are compounds with one or more fructosyl-fructose linkages. Inulin is material with mostly or exclusively a B(2-1) fructosyl-fructose linkage. In most cases a glucose moiety can be found at the end of the fructose chain. This is why inulin is often summarized as G(F)n. (n stands for the amount of fructose units attached to the glucose) For inulin oligomers with a chain length varying between 2 and 60 fructose units, the terms fructooligosaccharide or oligofructose are often used. Inulin is a fructooligosaccharide (FOS) derived from chicory by a process similar to that used in extracting sugar from sugar beets. It is white in color, slightly hygroscopic, water soluble and is not digested by monogastric animals. Commercially available inulin products contain between 80% and 99% inulin (averaging between 8-10 fructose units).

Available native starches include tapioca, corn, waxy corn (waxy maize), high amylose corn, wheat, rice, sorghum, and potato starches. Unmodified flour will include rice flour, barley flour, and wheat flour.

The carbohydrate water binder will be added in an amount ranging between 2% and 25% by weight of the soft frozen purée. More preferably, the water binder is added in an amount ranging between 5% and 20% by weight of the soft frozen purée. If inulin is used in a garlic purée formulation, for example, it is most preferred to add it in an amount equal to about 15% by weight of the garlic purée composition. The amount of carbohydrate water binder will vary dependent upon the plant material being used and the particular water binder selected. Additionally, the amount added is dependent upon the desired final characteristics of the soft frozen purée composition. In particular, it is desired to minimally impact the flavor of the frozen purée composition. As such, the carbohydrates should only be added in an amount sufficient whereby it will not cause the finished product to have a sweetened flavor. The water binder must also be added in an amount sufficient to achieve the desired final characteristics of the product.

Combinations of two or three carbohydrate water binders may be necessary in some applications. It is desired for example to combine inulin and tapioca starch, whereby the inulin is added in an amount equal to between 5% and 25% by weight of the purée, and the second carbohydrate is added in an amount equal to between 5% and 25% by weight of the purée. A third carbohydrate added maybe added in an amount equal to between 0.1% and 10%. It is preferred to use inulin in combination with a carbohydrate water binder, with inulin present in a greater amount.

In the alternative, an amount of salt may be mixed with the plant material and carbohydrate water binder. The salt is added because it is effective in reducing the freezing point of the finished composition even when added in comparatively small quantities. Different types of salt that can be used include sodium chloride (common salt), sodium or potassium phosphates, citrates, chlorides, and the like. The salt can be added in an amount ranging between 0.1% and 10% by weight of the frozen purée composition. More particularly, the salt can be added in an amount ranging between 0.5% and 6% by weight of the frozen purée composition.

Food grade acids such as phosphoric, tartaric, malic, citric, fumaric, hydrochloric, gluconic, and similar food grade acidulants maybe added to control pH or serve as preservatives. Gluconic acid, added in the form of glucono-delta-lactone, is particularly suitable because it imparts very little sour taste to the final product. The acid can be added in an amount ranging between 0.1% and 5.0% by weight of the composition. More preferably, the acid is added in an amount ranging between 0.5% and 1.5% by weight of the frozen purée composition.

Once the plant material is selected, the selected constituents are added to the purée and mixed to form a mixed purée composition. It is then necessary to freeze the mixed purée composition. This is generally accomplished by placing the mixed purée composition in a freezer at a temperature of less than 0° C.

The resultant soft frozen purée composition should have a total dextrose and fructose content ranging between 1% and 5% by weight of the purée. Additionally, it is desired if at least trace amounts of glucose and sucrose are present in the soft frozen purée. The purée composition should have maximum stress, at approximately 22° F., at between 0.001 kPa and 5.000 kPa. This measurement relates to the softness or scoopability of the finished composition.

The resultant frozen purée composition has a soft frozen texture, which enables it to be immediately used after removal from frozen storage. The resultant product will likely contain added ingredients comprised mainly of disaccharides, oligosaccharides, fructans, polysaccharides, starches, starch hydrolysis products, flours, and polyols which impart very little or no sweetness, but still perform as cryostabilizers or cryoprotectants. The product is mildly processed to minimize the breakdown of key flavor compounds responsible for the characteristic natural fresh flavor of the original plant material. Finally, the product has comparatively better flavor and color retention when kept in ambient or refrigeration storage for a prolonged period of time.

The current invention does not contribute any flavor impact to the respective soft frozen product, thereby resulting in a more natural tasting (less sweet) soft frozen product. This reduced the application limitations where sweetness was a hindrance of the base ingredient. The combination of ingredients added in the current invention does not lead to gel formation. If there are no gels that form then the material will not be gummy or pasty before or during heating.

Importantly, the present frozen purée composition does not contain fructose or dextrose as the added key ingredient and therefore is comparatively less sweet. Also, the purée does not contain significant amounts of reducing sugars and therefore does not undergo Maillard-type reactions (nonenzymatic browning reactions), which can result in off-odors, off-flavors and browning during sauteing, frying, roasting, baking or storage.

The resultant purée of this invention can be used in gourmet sauces, salad dressings, soups, frozen or refrigerated entrees, toppings and flavored butters and cheeses, pasta sauces, cooking sauces, salsas, marinades, deli salads, meat preparations etc.

The product of this invention contains cryostabilizers and cryoprotectants which render it soft frozen and “ready for use” upon removal from the freezer unlike their 100% frozen counterparts. The product of this invention can be refrozen without compromising piece integrity in contrast to dehydrofrozen or IQF products.

The invention also relates to an unfrozen purée composition. The composition includes room temperature plant material and a room temperature carbohydrate water binder

### EXAMPLES

### Example 1

A garlic purée product was prepared as disclosed below. In particular, it was desired to test for substitutes for the inulin.

The steps for making the product are as follows:

All the dry ingredients were pre-weighed into separate 2 oz. containers according to the formulation list below. The garlic purée was added based on the amount in the formulation list. The mixture was thoroughly blended, whereby the garlic purée was mixed completely with the dry ingredients (no lumps). Each container was covered and frozen for at least 24 hours.

The compositions are listed in the following table:

| | | Carbohydrate | | | | | |
|---|---|---|---|---|---|---|---|
| | | A | B | C | D | E | F |
| | | Inulin- | RF- | P12082- | Clinton | PAC-GEL | SRF- |
| | | HD | 70111 | PS | 185 | 120 | 200111 |
| | % | g | g | g | g | g | g |
| Garlic Purée | 81.0 | 24.3 | 24.3 | 24.3 | 24.3 | 24.3 | 24.3 |
| Carbohydrate | 15.0 | 4.5 | 4.5 | 4.5 | 4.5 | 4.5 | 4.5 |
| Ingredients | | | | | | | |
| Salt | 4.0 | 1.2 | 1.2 | 1.2 | 1.2 | 1.2 | 1.2 |
| Total | 100.0 | 30.0 | 30.0 | 30.0 | 30.0 | 30.0 | 30.0 |
| | | | | | J | K | |
| | | G | H | | MST | UT | L |
| | | PAC- | CWRF- | I | Mod. | Tapioca | Remyflo |
| | | GEL 45 | 4511 | Perlene | Food St. | St. | S200 |
| | % | g | g | g | g | g | g |
| Garlic Purée | 81.0 | 24.3 | 24.3 | 24.3 | 24.3 | 24.3 | 24.3 |
| Carbohydrate | 15.0 | 4.5 | 4.5 | 4.5 | 4.5 | 4.5 | 4.5 |
| Ingredients | | | | | | | |
| Salt | 4.0 | 1.2 | 1.2 | 1.2 | 1.2 | 1.2 | 1.2 |
| Total | 100.0 | 30.0 | 30.0 | 30.0 | 30.0 | 30.0 | 30.0 |
| | | | | | P | | |
| | | M | N | O | Viscogel | Q | |
| | | Remyflo | Remyline | Remyline | 87 | Clintose | R |
| | | S500P | DR | AX-DR | 4387 | CR-10 | 064051 |
| | % | g | g | g | g | g | g |
| Garlic Purée | 81.0 | 24.3 | 24.3 | 24.3 | 24.3 | 24.3 | 24.3 |
| Carbohydrate | 15.0 | 4.5 | 4.5 | 4.5 | 4.5 | 4.5 | 4.5 |
| Ingredients | | | | | | | |
| Salt | 4.0 | 1.2 | 1.2 | 1.2 | 1.2 | 1.2 | 1.2 |
| Total | 100.0 | 30.0 | 30.0 | 30.0 | 30.0 | 30.0 | 30.0 |
| | | | T | U | | W | X |
| | | S | Purity | National | V | C Polar | C Text |
| | | Ultra- | GUM | 711 Food | Instant | Text | Instant |
| | | Sperse M | 539 | Starch | Clearjel | Instant | 12604 |
| | % | g | g | g | g | g | g |
| Garlic Purée | 81.0 | 24.3 | 24.3 | 24.3 | 24.3 | 24.3 | 24.3 |
| Carbohydrate | 15.0 | 4.5 | 4.5 | 4.5 | 4.5 | 4.5 | 4.5 |
| Ingredients | | | | | | | |
| Salt | 4.0 | 1.2 | 1.2 | 1.2 | 1.2 | 1.2 | 1.2 |
| Total | % | 30.0 | 30.0 | 30.0 | 30.0 | 30.0 | 30.0 |

| | | Y | | AA | |
|---|---|---|---|---|---|
| | | 18 DE Malto- | Z | Clarified Brown | BB |
| | | Dextrine | Coscoe Dextrine | Rice Syrup | Inulin HD |
| | | g | g | g | g |
| Garlic Purée | 81.0 | 24.3 | 24.3 | 24.3 | 145.8 |
| Carbohydrate | 15.0 | 4.5 | 4.5 | 4.5 | 27.0 |
| Ingredients | | | | | |
| Salt | 4.0 | 1.2 | 1.2 | 1.2 | 7.2 |
| Total | 100.0 | 30.0 | 30.0 | 30.0 | 180.0 |

Description of carbohydrates used:

A. Inulin-HD by Cargill.

B. RF-70111—rice flour by Pacific Grain Prods. Int'l (Div. of ACH Food Comp).

C. P120821-PS—pregelatinized rice flour by Pacific Grain Prods. Int'l (Div. of ACH Food Comp).

D. Clinton 185—corn starch by ADM.

E. PAC-GEL 120—pregelatinized rice flour by Pacific Grain Prods. Int'l (Div. of ACH Food Comp) PGP.

F. SRF-20111—Extra fine rice flour by PGP.

G. PAC-GEL 45—pregelatinized rice flour by PGP.

H. CWRF-4511—rice flour by PGP.

I. Perlene—barley flour by The Ettlinger Corporation.

J. MST Modified Food Starch—modified tapioca starch by The Ettlinger Corporation.

K. UT Tapioca Starch—tapioca starch from cassava root by The Ettlinger Corporation.

L. Remyflo S200—waxy rice flour by A&B Ingredients.

M. Remyflo S500P—pre-cooked waxy rice flour by A&B Ingredients.

N. Remyline DR—fine waxy rice starch by A&B Ingredients.

O. Remyline AX-DR—fine neutral waxy rice starch by A&B Ingredients.

P. Viscogel 87 4387—modified waxy starch by Cargill.

Q. Clintose CR-10—maltodextrine by ADM.

R. 064051—Snowflake™ modified food starch by Corn Products Int'l.

S. Ultrasperse—cold water swelling modified food starch from waxy maize by National Starch and Chemical Corp.

T. Purity Gum 539—pregelatinized emulsion stabilizing starch by National Starch and Chemical Corp.

U. National 711—pregelatinized modified food starch by National Starch and Chemical Corp.

V. Instant Clearjel—pregelatinized modified food starch by National Starch and Chemical Corp.

W. C Polar Text Instant—pregelatinized, stabilized and cross-linked waxy maize starch by Cerestar, a division of Cargill.

X. C Test Instant 12604—pregelatinized, modified food starch by Cerestar, a division of Cargill.

Y. 18 DE Maltodextrine—maltodextrine by Corn Products Int'l.

Z. Coscoe Dextrine—dextrine by Corn Products Int'l.

AA. Brown Rice Syrup—clarified med. conversion brown rice syrup 60 DE by California Natural Prods.

The composition in column BB contained inulin-HD and was the control sample. A bigger amount of the control sample was prepared so several small 30.0 g containers could be filled. Each control container was compared with 5-6 prototypes at a time.

The results and observations are as follows. Most of the samples mixed very well and had almost the same consistency as the garlic purée without additives, but some samples changed in consistency after mixing. The following samples were noted to have a different consistency.

Sample—observation:

C—thick, almost “gummy”

E—slight thickening

F—slight thickening

M—slight thickening

S—slight thickening

T—thick mixture

U—thick mixture

V—thick, almost gummy

W—thick, gummy mixture

X—thick, almost gummy

### Example 2

The samples of Example 1 were tested to see which have a similar softness (after being taken out immediately from the freezer) to the inulin formulation (15% inulin+4% salt). The samples were removed from the freezer in groups of six or less, together with one frozen sample of the inulin formulation. The results were then recorded as harder, softer, or equal to the inulin formulation in texture when a butter knife was pierced through the formulation.

Results and Discussions

| Sample | |
|---|---|
| Codes | Evaluation |
| S | same softness as inulin, slight yellow instead of creamy |
| K | same softness as inulin, and also looks the same visually |
| N | same softness as inulin, and also look the same visually |
| V | same softness as inulin, slight yellow instead of creamy |
| Q | same softness as inulin, slight yellow instead of creamy |
| G | same softness as inulin, slight yellow instead of creamy |
| Y | softer than inulin, slight yellow instead of creamy |
| AA | softer than inulin, slight yellow instead of creamy |
| H | slightly harder than inulin, slight yellow instead of creamy |
| U | slightly harder than inulin, slight yellow instead of creamy |
| D | same softness as inulin, and also looks the same |
| X | same softness as inulin, slight yellow instead of creamy looking |
| T | same softness as inulin, and also looks the same visually |
| R | same softness as inulin, and also looks the same visually |
| J | same softness as inulin, and also looks the same visually |
| C | same softness as inulin, slight yellow instead of creamy |
| Z | softer than inulin, has orange tinge |
| F | harder than inulin |
| I | same softness as inulin, slight yellow instead of creamy |
| P | same softness as inulin and also looks the same visually |
| E | slightly harder than inulin, but looks the same visually |
| M | slightly harder than inulin, but looks the same visually |
| L | slightly harder than inulin, slight yellow instead of creamy |
| W | same softness as inulin, slight yellow instead of creamy |
| B | same softness as inulin and looks the same visually |
| O | slightly harder than inulin but looks the same visually |

It was concluded that there are samples that behave similar to the inulin formulation in terms of softness and visual appearance. The samples were kept in ambient storage for two weeks and evaluated thereafter.

### Example 3

The samples of Example 1 were again evaluated. The samples were compared to see which ones had the same color as the inulin formulation (BB). This compared the color of the samples to the inulin formulation.

The samples were set out at ambient temperature for two weeks and compared thereafter to see if there were samples that not only had the same softness as the inulin formulation but also prevented weeping and slowed down flavor degradation.

Results and Discussion

The following samples had the same creamy color as the inulin formulation, no signs of weeping.

D—corn starch Clinton 185

J—modified tapioca starch

K—UT tapioca starch, has better texture than inulin (inulin is slightly thick)

N—fine waxy rice starch Remyline DR

O—fine, neutral waxy rice starch Remyline AX-DR

The following samples had a slightly more yellow color than the inulin formulation, no signs of weeping.

F—SRF-20111 extra fine rice flour

P—Viscogel 87, 4387 modified waxy

R—Snowflake modified food starch 064051, has a slight sour taste

H—rice flour CWRF-4511

B—rice flour 7011

All the other samples had even darker yellow colors than those under A or B.

### Example 4

The present example relates to comparison of different formulations when heated. The formulas are as follows:

| | % | grams |
|---|---|---|
| R&D#495-21F | | |
| Garlic Purée | 70 | 1050 |
| High Fructose Corn Syrup | 30 | 450 |
| | 100 | 1500 |
| R&D#495-21I | | |
| Garlic Purée | 81 | 1215 |
| Inulin-FP | 15 | 225 |
| Salt | 4 | 60 |
| | 100 | 1500 |
| R&D#495-21T | | |
| Garlic Purée | 81 | 1215 |
| UT Tapioca Starch | 15 | 225 |
| Salt | 4 | 60 |
| | 100 | 1500 |

The fourth sample was 100% garlic purée. All of the samples were frozen prior to the heat test.

The method was as follows:

A. Thaw purée samples to room temperature.

B. Preheat a non-stick griddle to 350° F.

C. Add 1 Tablespoon of purée at the center of the pan and move purée back and forth with a spatula for one minute.

D. Record observation.

Results and Discussion

A. (GF Garlic Purée with high fructose corn syrup) browned and lumped a little bit and there was some sticking on the pan.

B. 100% garlic purée—slight browning, lumped a little bit and there was some sticking on the pan.

C. (garlic purée with inulin) there was slight browning, the sample spread well, and did not stick much.

D. (garlic purée with tapioca) there was slight browning, the sample got sticky and gooey.

The inulin sample performed the best and seems to be better than 100% garlic purée in terms of not lumping while being cooked. The tapioca sample performed the worst in terms of being very sticky.

### Example 5

The present Example relates to forming a garlic purée using different types of flour. The listed constituents were blended together to achieve a smooth constituency.

The formulas are as follows:

R&D #495-26-A

| | | |
|---|---|---|
| Garlic Purée | 81% | 81 grams |
| Wheat Flour | 15% | 15 grams |
| Kosher Salt | 4% | 4 grams |

Flour Used - Gold Medal ® all purpose unbleached wheat flour from
Safeway
Note: Sample blended well.

R&D #495-26-B

| | | |
|---|---|---|
| Garlic Purée | 81% | 81 grams |
| Wheat Flour | 15% | 15 grams |
| Kosher Salt | 4% | 4 grams |

Flour Used - ACH-7011 fine white rice flour.
Note: Sample blended well.

R&D #495-26-C

| | | |
|---|---|---|
| Garlic Purée | 81% | 81 grams |
| Wheat Flour | 15% | 15 grams |
| Kosher Salt | 4% | 4 grams |

Flour Used - ACH-200111 super fine rice flour.
Note: Sample blended well.

R&D #495-26-D

| | | |
|---|---|---|
| Garlic Purée | 81% | 81 grams |
| Wheat Flour | 15% | 15 grams |
| Kosher Salt | 4% | 4 grams |

Flour Used - ACH-45111 coarse white rice flour.
Note: Sample blended well.

R&D #495-26-E

| | | |
|---|---|---|
| Garlic Purée | 81% | 81 grams |
| Wheat Flour | 15% | 15 grams |
| Kosher Salt | 4% | 4 grams |

Flour Used - Perlene barley flour - Ettlinger Corp.
Note: Sample blended well.

Evaluation of Samples:

A. R&D #495-26-A

Softness, flavor and color are acceptable. The product failed the heat test. When heated, the product turned to paste.

B. R&D #495-26-B

Softness, flavor and color are acceptable. Failed heat test. Product turned to paste.

C. R&D #495-26-C

Softness, flavor and color are acceptable. Failed heat test. Product turned to paste.

D. R&D #495-26-D

Softness, flavor and color are acceptable. Failed heat test. Product turned to paste.

E. R&D #495-26-E

Softness, flavor and color are acceptable. Failed heat test. Product turned to paste.

Conclusion: All samples failed the heat test. When subjected to heat, the garlic purée became very thick and pasty. However, the above formulations could still be used in food applications that do not require further heating like salad dressings, toppings, salsas, flavored butters etc.

### Example 6

The present example relates to preparation of other garlic purée formulations that are comparable to the inulin prototype.

The steps for making the product are as follows:

All the different ingredients were weighed into separate plastic containers as listed below. Each of the blends was mixed thoroughly and then transferred into 2-2 oz containers (30 grams each). The containers were stored in the freezer for at least 24 hours prior to evaluation.

| | A | | B | | C | | D | |
|---|---|---|---|---|---|---|---|---|
| | % | g | % | g | % | g | % | g |
| Garlic Purée | 80.0 | 60.0 | 80.0 | 60.0 | 83.0 | 62.2 | 90.0 | 67.5 |
| Glycerine | 10.0 | 7.5 | 15.0 | 11.2 | 10.0 | 7.5 | 10.0 | 7.5 |
| Inulin HD | 10.0 | 7.5 | 5.0 | 3.8 | 5.0 | 3.8 | — | — |
| Salt | — | — | — | — | 2.0 | 1.5 | — | — |
| Total | 100.0 | 75.0 | 100.0 | 75.0 | 100.0 | 75.0 | 100.0 | 75.0 |
| | E | | F | | G | | H | |
| | % | g | % | g | % | g | % | g |
| Garlic Purée | 85.0 | 63.8 | 88.0 | 66.0 | 81.0 | 60.8 | 81.0 | 60.8 |
| Glycerine | 15.0 | 11.2 | 10.0 | 7.5 | — | — | — | — |
| Inulin HD | — | — | — | — | — | — | 15.0 | 11.2 |
| HSH 3375 | — | — | — | — | 15.0 | 11.2 | — | — |
| Salt | — | — | 2.0 | 1.5 | 4.0 | 3.0 | 4.0 | 3.0 |
| Total | 100.0 | 75.0 | 100.0 | 75.0 | 100.0 | 75.0 | 100.0 | 75.0 |

I

| | % | g |
|---|---|---|
| Garlic Purée | 70.0 | 52.5 |
| High Fructose Corn Syrup | 30.0 | 22.5 |
| Total | 100.0 | 75.0 |

The HSH 3375 ingredient is Hydrogenated Starch Hydrolysate which has 15% Sorbitol and 30% Maltitol.

### Example 7

The samples of Example 6 were tested to determine the softness of samples when compared with the Inulin (sample H) and Fructose (sample I) formulations. A butter knife was pierced through the frozen purée.

Results and Discussion

A—softer than samples H and I.

B—softer than Samples H and I.

C—softer than samples H and I.

D—similar in softness to samples H and I

E—softer than samples H and I.

F—softer than samples H and I.

G—softer than samples H and I.

All the frozen purée formulations prepared with the exception of Sample D were softer than the Inulin (Sample H) and Fructose (Sample I) formulations. These did not contain ingredients which gelatinize on heating. These samples also did not contain significant amounts of reducing sugars that are involved in Maillard-type browning reactions.

### Example 8

A garlic purée product was formed using inulin HD. The process was as follows:

A. 100% garlic purée was blended with salt and inulin HD.

B. The mixture was then frozen.

The formulations are as follows:

R&D #495-02-A

| | | | |
|---|---|---|---|
| Garlic Purée | 84% | 252 | grams |
| Inulin HD | 15% | 45 | grams |
| Kosher Salt | 1% | 3 | grams |
| Total | 100% | 300 | grams |

R&D #495-02-B

| | | | |
|---|---|---|---|
| Garlic Purée | 83% | 249 | grams |
| Inulin HD | 15% | 45 | grams |
| Kosher Salt | 2% | 6 | grams |
| Total | 100% | 300 | grams |

Evaluated Samples A & B. Sample A was not soft enough. Sample B was better but it still needs to be softer.

R&D #495-02-C

| | | | |
|---|---|---|---|
| Garlic Purée | 78% | 234 | grams |
| Inulin HD | 20% | 60 | grams |
| Kosher Salt | 2% | 6 | grams |
| Total | 100% | 300 | grams |

Evaluated Sample C and it is still not quite soft enough.

R&D #495-02-D

| | | | |
|---|---|---|---|
| Garlic Purée | 81% | 243 | grams |
| Inulin HD | 15% | 45 | grams |
| Kosher Salt | 4% | 12 | grams |
| Total | 100% | 300 | grams |

R&D #495-02-E

| | | | |
|---|---|---|---|
| Garlic Purée | 77% | 231 | grams |
| Inulin HD | 20% | 60 | grams |
| Kosher Salt | 3% | 9 | grams |
| Total | 100% | 300 | grams |

Evaluated Samples D & E. They were both acceptable in softness and flavor.

### Example 9

Garlic purée samples were studied for ambient shelf life.

Procedure

A. Garlic cloves were washed.

B. The cloves were steamed for 60 seconds in 5 lb. batches.

C. The garlic was cooled with ambient water.

D. The garlic was ground through a mince master, 1.2 mil plate.

E. The garlic mixture was blended and frozen.

The formulations were as follows:

R&D #495-08-A

| | |
|---|---|
| Frozen Garlic Purée | 100% |

R&D #495-08-B

| | |
|---|---|
| Garlic | 81% |
| Inulin HD | 15% |
| Salt | 4% |

R&D #495-08-C

| | |
|---|---|
| Garlic | 84% |
| Trehalose | 15% |
| Salt | 1% |

R&D #495-08-D

| | |
|---|---|
| Garlic | 70% |
| Fructose | 30% |

Note:
A 5 lb. Sample of each formula was made. Samples of each formula were taken to the Lab for micro and analytical testing.

Samples being tested:

A. R&D #495-08-A—100% garlic purée

B. R&D #495-08-B—inulin HD and salt blend

C. R&D #495-08-C—trehalose and salt blend

D. R&D #495-08-D—fructose blend

A 5 lb. tub of each formula was taken from the freezer and placed on the lab counter. A small sample of each was put in the refrigerator at 40° to 45° F. One small sample of each was retained in the freezer.

Beginning Lab Results

| | | | | | Lactic | | | |
|---|---|---|---|---|---|---|---|---|
| | | | | E. | Acid | | | |
| | pH | % SS | Coliform | coli | MR | Yeast | Mold | SPC |
| #495-08-A | 5.9 | 33.6 | <10 | <10 | 20 | <10 | <10 | 510 |
| #495-08-B | 5.4 | 45.4 | <10 | <10 | <10 | <10 | <10 | 840 |
| #495-08-C | 5.7 | 43.8 | <10 | <10 | 20 | <10 | <10 | 600 |
| #495-08-D | 5.9 | 43.6 | <10 | <10 | <10 | <10 | <10 | 500 |

Evaluation of samples—1 week at ambient temperature

A. 100% garlic—Color was good; had gotten slightly darker. Aroma was good; had a nice fresh garlic smell. Flavor—tested sample from tub. Still has good garlic flavor. Seemed to have lost some of the heat. Overall, the sample was determined to be acceptable.

B. Inulin HD—Color was very good; it didn't seem to have changed. Aroma had a good garlic aroma. Flavor had a very strong garlic flavor. Had not lost the heat.

C. Trehalose—Color was good. It was slightly darker than B. Aroma—good garlic. Flavor—very strong garlic flavor. Better than A.

D. Fructose—Color was good, slightly darker than B. Aroma—good garlic. Flavor—good garlic very sweet. This sample was the sweetest of all. That was because it was blended with fructose.

Conclusion: Sample B was the best for flavor and color. It was determined to be better than the other three samples. Samples C & D were the same as far as color and garlic flavor. Sample D was much sweeter. Sample A was the worst of all—color was darker and flavor was starting to leave.

### Example 10

The following is further analysis of the samples in Example 9.

Lab Results from 9/19 samples

| | | | | | Lactic | | | |
|---|---|---|---|---|---|---|---|---|
| | | | | E. | Acid | | | |
| | pH | % SS | Coliform | coli | MR | Yeast | Mold | SPC |
| #495-08-A | 5.7 | 33.6 | <10 | <10 | <10 | <10 | <10 | 970 |
| #495-08-B | 5.2 | 43.0 | <10 | <10 | <10 | <10 | <10 | 1200 |
| #495-08-C | 5.5 | 43.2 | <10 | <10 | <10 | <10 | <10 | 1100 |
| #495-08-D | 5.7 | 43.4 | <10 | <10 | <10 | <10 | <10 | 800 |

Evaluation of samples—2 weeks at ambient temperature

A. #495-08-A—100% garlic purée—Color was slightly darker than Sample B. It was slightly darker than the refrigerated sample. It had a good aroma but not as strong as the other samples. Taste—had fair garlic taste but no heat.

B. #495-08-B—Inulin HD and salt blend—Had very good color; it was the best color of all ambient samples. It was slightly darker than the refrigerated sample. Aroma—had a very good garlic smell. Taste—had a very strong garlic flavor with lots of heat.

C. #495-08-C—Trehalose and salt blend. Color was slightly darker than B. The ambient sample was slightly darker than the refrigerated sample. Aroma—had a good garlic smell. Taste—good garlic flavor plus heat.

D. #495-08-D—Fructose blend. Color was darker than B and was more liquid than other samples. The ambient sample was darker than the refrigerated sample. Aroma—had a good garlic smell. Taste—very sweet, good garlic flavor plus heat.

Conclusion: Overall Sample B was the best. The color and flavor was better than the other samples. Samples C and D had better flavor than Sample A and their color was slightly better than A. All samples were acceptable, with Sample A being the worst and Sample B the best.

### Example 11

The following is further analysis of the samples of Example 9.

Lab Results from 9/26 samples

| | | | | | Lactic | | | |
|---|---|---|---|---|---|---|---|---|
| | | | | E. | Acid | | | |
| | pH | % SS | Coliform | coli | MR | Yeast | Mold | SPC |
| #495-08-A | 5.8 | 33.0 | <10 | <10 | <10 | <10 | <10 | 950 |
| #495-08-B | 5.3 | 43.0 | <10 | <10 | <10 | <10 | <10 | 800 |
| #495-08-C | 5.5 | 42.8 | <10 | <10 | <10 | <10 | <10 | 700 |
| #495-08-D | 5.6 | 43.2 | <10 | <10 | <10 | <10 | <10 | 730 |

Three week evaluation of samples at ambient temperature

A. #495-08-A—100% garlic purée. Color was slightly dark and turning more yellow.

Color was still acceptable. It was darker than the refrigerated sample. Aroma—wasn't as strong as refrigerated but was acceptable. Flavor—very little flavor, no heat. Sample was unacceptable because of flavor.

B. #495-08-B—Inulin and salt. Color was still very good, slight yellowing on edges, but acceptable. Aroma—very strong. Flavor—very strong garlic flavor. Product was acceptable.

C. #495-08-C—Trehalose and salt. Color—product was starting to turn yellow, some weepage. Aroma—product had a good garlic smell but not as good as B. Flavor—good garlic flavor but not as good as B. Overall product was acceptable.

D. #495-08-D—Fructose. Color—slightly yellow, a lot of weepage. Aroma—a very mild garlic smell. Taste—very sweet, not much garlic flavor. This product was barely acceptable because of the flavor.

Conclusion: All the samples were slightly darker than the refrigerated samples. Flavor was better on refrigerated samples. Sample B was the best of all. Sample C was next best. It was still acceptable. Sample D was next best. The flavor on this was getting very weak. It was barely acceptable. Sample A was not acceptable because of flavor.

### Example 12

This example relates to the samples of Example 9.

Four Week Evaluation.

A. Sample A—100%. This sample was unacceptable. The color was too dark, the aroma was very bad and it had no taste.

B. Sample B—Slightly yellow in color, aroma was good and flavor was very good. Acceptable.

C. Sample C—Some weepage, sample was getting darker, the aroma was slightly off or strong, flavor was getting weak. Overall, still acceptable.

D. Sample D—Color was still acceptable but getting darker, aroma was getting strong, flavor sweet, weak garlic flavor. The product was barely acceptable.

Conclusion: All samples aren't as good as the refrigerated samples. Sample B was still very acceptable. C & D were barely acceptable and A was unacceptable.

The inulin HD formulation still performed the best among the 4 formulations in terms of smell, color and no liquid separation.

These samples were prepared on Sep. 10, 2002 and set at ambient storage starting on Sep. 12, 2002. So samples were almost 7½weeks old.

### Example 13

This Example relates to preparing a garlic purée for use in testing.

R&D #495-29-A

| | | | |
|---|---|---|---|
| Garlic Purée | 70% | 210 | grams |
| Fructose | 30% | 90 | grams |
| Total | 100% | 300 | grams |

R&D #495-29-B

| | | | |
|---|---|---|---|
| Garlic Purée | 81% | 243 | grams |
| Inulin | 15% | 45 | grams |
| Kosher Salt | 4% | 12 | grams |
| Total | 100% | 300 | grams |

R&D #495-29-C - This sample was 100% garlic Purée, Lot #02170101.
Moisture Results.
A. R&D #495-29-A - 55.1%
B. R&D #495-29-B - 55.6%
C. R&D #495-29-C - 64.0%

### Example 14

A garlic purée product was formed and tasted. Different amounts of inulin and fructose were blended with the garlic purée. The finished product was analyzed to determine whether inulin would extend the shelf life of the garlic purée product.

The procedure was as follows:

1. Garlic purée was made.

2. Fructose, inulin and the garlic purée were blended to form the garlic purée product.

3. The garlic purée product was packed and frozen overnight in a walk-in freezer.

4. The next day the product was removed from freezer and analyzed for softness.

5. The samples were then placed on a counter and left at ambient temperature to see if the samples with inulin resulted in better quality than the samples without inulin.

| | % of Constituent by Weight |
|---|---|
| Sample A - Regular Garden Frost | |
| Garlic Purée | 70% |
| Fructose | 30% |

After 24 hours in freezer product was soft.

| | |
|---|---|
| Sample B | |
| Garlic | 70% |
| Fructose | 25% |
| Inulin | 5% |

After 24 hours product was as soft as Sample A.

| | |
|---|---|
| Sample C | |
| Garlic | 70% |
| Fructose | 20% |
| Inulin | 10% |

After 24 hours product was not quite as soft as Sample A, but it was
acceptable.

| | |
|---|---|
| Sample D | |
| Garlic | 70% |
| Fructose | 15% |
| Inulin | 15% |

After 24 hours product was not as soft as samples A, B or C, but was
still acceptable.

| | |
|---|---|
| Sample E | |
| Garlic | 70% |
| Fructose | 10% |
| Inulin | 20% |

After 24 hours product was too hard. Product was unacceptable and
discarded.

| | |
|---|---|
| Sample F | |
| Garlic | 70% |
| Fructose | 5% |
| Inulin | 25% |

Product too hard. Discarded.

| | |
|---|---|
| Sample G | |
| Garlic | 70% |
| Inulin | 30% |

Product too hard. Discarded.

The samples were evaluated after 20 days ambient temperature.

Discussion of the results.

Sample A had 30% fructose. This was a control formulation. The color was too dark. The sample looked like applesauce. Aroma—sample had a strong garlic smell. Taste—sample was sweet but has good garlic flavor. The sample failed because color was too dark.

Sample B had 25% fructose, 5% inulin. Color was slightly lighter than A but still too dark. Aroma and flavor were good and was as sweet as A. Failed because of color.

Sample C had 20% fructose, 10% inulin. The sample was lighter in color than A and B—color was acceptable. Strong garlic flavor, less sweet than A and B. Sample was acceptable.

Sample D had 15% fructose, 15% inulin. Color was better than A, B and C. Color had gotten slightly darker than at 0 time. Flavor was good, but had a slight bitter taste. Sample was acceptable.

100% Garlic Puree. Sample was very dark and not acceptable. Flavor was good.

Conclusion: The more inulin blended with the fructose and garlic, the longer the ambient shelf life. More than 15% inulin cannot be added because the frozen product will not be soft enough.

### Example 15

Another garlic purée product was formed for use in sugar analysis.

The procedure was as follows:

1. Garlic purée was made.

2. The below listed ingredients were weighed and blended.

3. The garlic purée product was packed and frozen.

4. The samples were tested.

| | % of Constituent by Weight | Weight by grams | |
|---|---|---|---|
| Sample F | | | |
| Garlic Purée | 70% | 1050 | gm |
| HFCS - high | 30% | 450 | gm |
| fructose corn syrup | | | |
| Total: | 100% | 1500 | gm |
| Sample I | | | |
| Garlic Purée | 81% | 1215 | gm |
| Inulin - IN-FP | 15% | 225 | gm |
| Salt | 4% | 60 | gm |
| Total: | 100% | 1500 | gm |
| Sample T | | | |
| Garlic Purée | 81% | 1215 | gm |
| U-T-Tapioca Starch | 15% | 225 | gm |
| Salt | 4% | 60 | gm |
| Total: | 100% | 1500 | gm |

The following are the results of sugar analysis testing performed on the different garlic purée samples.

| | | | |
|---|---|---|---|
| Assay | Component | Results | Units |

Sample F - Garlic Purée HFCS

| | | | |
|---|---|---|---|
| Sugars by HPLC | Total Sugar | 18.4 | % |
| | Fructose | 7.68 | % |
| | Glucose | 9.50 | % |
| | Sucrose | 0.57 | % |
| | Maltose | 0.68 | % |
| | Lactose | 0.00 | % |

Sample I - Garlic Purée Inulin

| | | | |
|---|---|---|---|
| Sugars by HPLC | Total Sugar | 1.34 | % |
| | Fructose | 0.00 | % |
| | Glucose | 0.32 | % |
| | Sucrose | 1.02 | % |
| | Maltose | 0.00 | % |
| | Lactose | 0.00 | % |

Sample T - Garlic Purée Tapioca

| | | | |
|---|---|---|---|
| Sugars by HPLC | Total Sugar | 0.460 | % |
| | Fructose | 0.00 | % |
| | Glucose | 0.07 | % |
| | Sucrose | 0.39 | % |
| | Maltose | 0.00 | % |
| | Lactose | 0.00 | % |

Discussion:

In terms of the types and amounts of sugar present in the different samples, the order is as follows:

The high fructose formulation had high levels of fructose and glucose, which contributed to the sweetness of the product.

The inulin formulation had no fructose, but had glucose and some sucrose, contributing to the sweet taste.

The tapioca starch formulation had no fructose and very little glucose, with less than 1% sucrose.

With sucrose as the reference sugar at 100%, fructose had relative sweetness between 100-180 and, therefore, its presence, or absence, in any formulation could significantly have an impact on the perceived sweetness.

Conclusion:

The inulin and tapioca prototypes were better samples compared to the fructose formulation in terms of providing a more natural tasting garlic purée. The presence of high amounts of fructose and dextrose in the High Fructose Corn Syrup formulation is indicative of a product that is prone to Maillard type of browning reactions during heating.

### Example 16

The present example was intended to determine what ingredient substitutes for garlic purée product perform better or similar to the inulin prototype.

The same procedure as Example 1 was followed except different ingredients were used.

| | | GARLIC FORMULATION | | | | | |
|---|---|---|---|---|---|---|---|
| | | | | | | E | F |
| | | | | | | Paselli | Paselli |
| | | | | C | D | Modified | Modified |
| | | | B | Native | Unmodified | Tapioca | Potato |
| | | A | White | Potato | Native | Starch | Starch |
| | | Inulin | Flour | Starch | Tapioca | EZ2909 | EZ1903 |
| | % | g | g | g | g | g | g |
| Garlic Purée | 81.0 | 24.3 | 24.3 | 24.3 | 24.3 | 24.3 | 24.3 |
| Carbohydrate Ingredient | 15.0 | 4.5 | 4.5 | 4.5 | 4.5 | 4.5 | 4.5 |
| Salt | 4.0 | 1.2 | 1.2 | 1.2 | 1.2 | 1.2 | 1.2 |
| TOTAL | 100.0 | 30.0 | 30.0 | 30.0 | 30.0 | 30.0 | 30.0 |

The following carbohydrates when mixed with the garlic purée and salt caused the mixture to be thick and somewhat “gummy”.

E—thick, almost gummy

F—thick, almost gummy

### Example 17

The present example relates to the samples in Example 15 to determine the performance of the samples after freezing and when heated.

The same procedure as Example 4 was followed for the heat (or cook) test and the procedure for Example 2 was followed to determine softness.

Results and Discussions

A. Heat (or Cook) Test

A—Spread easily, just slightly pasty towards the end. Minimal browning.

B—Spread at first but became sticky and pasty towards the end. Minimal browning.

C—Spread at first but became sticky and pasty towards the end. Minimal browning.

D—Spread at first but became sticky and pasty towards the end. Minimal browning.

Only the inulin formulation did not become very sticky and pasty towards the end of cooking.

B. Softness

B—slightly harder than the inulin formulation.

C—harder than the inulin formulation.

D—same softness as the inulin formulation

E—slightly harder than the inulin formulation

F—harder than the inulin formulation

Even if samples F & C were rated as harder than the inulin formulation a butter knife still penetrated through the top part.

Conclusion

All samples were either comparable or just slightly harder than the inulin formulation. All the samples during heating exhibited minimal browning but only the inulin formulation spread easily throughout the heating process. The other ingredients (Native potato starch, Native tapioca starch and all purpose flour) could not be used by itself but could be combined with inulin if the purée is to be used in a heated food application.

### Example 18

The present Example relates to compression testing for different garlic purée samples. The softness and hardness of garlic purées were compared. The samples were as follows:

| | Sample A | | Sample B | | Sample C | |
|---|---|---|---|---|---|---|
| | % | g | % | g | % | g |
| Garlic Purée | 81.0 | 202.50 | 70.0 | 175.0 | 100.0 | 250.0 |
| | 15.0 | 37.50 | — | — | — | — |
| HFCS | — | — | 30.0 | 75.0 | — | — |
| Salt | | 10.0 | — | — | — | — |
| Total | 100.0 | 250.00 | 100.0 | 250.0 | 100.0 | 250.0 |

Methodology:

1. All dry ingredients were pre-weighed into 8 oz. containers according to the formulations listed.

2. The garlic purée (previously frozen and thawed) was added based on the amount in the formulation list.

3. Each mixture was blended thoroughly to make sure that the garlic purée was mixed completely with the dry ingredients (no lumps).

4. Each container was covered and frozen immediately for at least 12 hours.

5. The compression test measurements were conducted immediately after samples were taken out of the freezer.

Methodology

1. Test Parameter

Test Machine—Instron 5500R, Serial #55R4502, Instron Corporation

Software—Series IX Method

Method Type—Compressive

Test Method List

Load Cell—1 KNewton

High Extension—30.0 mm

Time Delay—120.0 seconds

Load Level—0.02 KN

High Load Level—1.00 KNewton

Crosshead Action—Stop and Return

Probe Diameter—5.90 mm

2. Test Procedure

A. Turn Instron “on” ½ hour to 1 hour prior to testing.

B. Turn computer on.

C. Set parameters (if doing for the first time); otherwise, refer to Test Method List

D. Go to the home screen in Series IX on the computer.

E. Get the sample from the freezer and measure sample height with a ruler on the side of the container.

F. Check product temperature. Readings should be done between 20.0°-23.0° F.

G. Click Test, type file name, Click OK, OK.

H. Change gauge (sample height measurement) if needed, then click OK.

I. Press jog down until the probe is close to the surface of the sample.

J. Use the fine jog knob to make sure the probe barely touches the surface of the sample.

K. Click reset balance load.

L. Click reset gauge length.

M. Click OK, OK.

N. Click start test—only if the sample temperature is between 20°-23° F.

O. Press jog up to move the probe up.

P. Clean the probe end. Reposition the container on the platform so a duplicate measurement can be made.

Q. Go to step H-O.

R. Go to step E if starting with a new sample to step Q.

S. Click end sample after all samples have been tested.

T. Click continue, OK.

U. Click save and file and printer.

V. Print results.

The testing method was Test 1.

Garlic Purée Sample C—100% Garlic Purée

Test 2 & 3

Garlic Purée Sample B—High Fructose Formulation

Test 4 & 5

Garlic Purée Sample A—Inulin+Salt Formulation

Test 6 & 7

Garlic Purée Comparison

| | Load | Displacement | Stress | % Strain |
|---|---|---|---|---|
| | at Maximum | at Maximum | at Maximum | at Maximum |
| Test Number | (N) | (mm) | (kPa) | (%) |
| 1 | −0.056 | −28.068 | −0.010 | −61.018 |
| 2 | 76.057 | 25.155 | 14.057 | 54.686 |
| 3 | 60.461 | 24.632 | 11.175 | 53.548 |
| 4 | 0.728 | 12.760 | 0.135 | 29.674 |
| 5 | 0.920 | 20.822 | 0.170 | 48.422 |
| 6 | 0.915 | 18.946 | 0.169 | 43.058 |
| 7 | 0.709 | 24.055 | 0.131 | 54.669 |

Summary of Results:

Summary of Results:

| | | Maximum Stress (kPa) |
|---|---|---|
| | Temp. ° F. | to Displace Sample |
| Sample C 100% Garlic Purée | 21.0 | 14.057 |
| | 23.0 | 11.175 |
| Average | | 25.232/2 = 12.62 kPa |
| Sample B Garlic Purée + HFCS | 21.0 | 0.135 |
| | 20.5 | 0.170 |
| Average | | 0.305/2 = 0.15 kPa |
| Sample A Garlic Purée + | 20.4 | 0.169 |
| Inulin + Salt | 22.6 | 0.131 |
| Average | | 0.300/2 = 0.15 kPa |

In the compression test that was performed the results show the big difference in maximum stress measurements between the 100% garlic purée and the two other formulations. The 100% garlic purée was extremely hard while the two samples were comparable in softness and did not need much pressure to cause a displacement (relating to spoonability or scoopability).

### Example 19

The present example relates to making the garlic purée product using different amounts of inulin, tapioca starch, and salt. The samples were used to perform heat tests to see if the purée would blend with the food and not bum.

Sample A

| | | | |
|---|---|---|---|
| Garlic Purée | 81% | 81 | g |
| Inulin | 15% | 15 | g |
| Salt | 4% | 4 | g |
| TOTAL | 100% | 100 | g |

Sample B

| | | | |
|---|---|---|---|
| Garlic Purée | 81% | 81 | g |
| Tapioca Starch | 15% | 15 | g |
| Salt | 4% | 4 | g |
| TOTAL | 100% | 100 | g |

Sample C

| | | | |
|---|---|---|---|
| Garlic Purée | 81% | 81 | g |
| Tapioca Starch | 10% | 10 | g |
| Inulin | 5% | 5 | g |
| Salt | 4% | 4 | g |
| TOTAL | 100% | 100 | g |

Sample D

| | | | |
|---|---|---|---|
| Garlic Purée | 81% | 81 | g |
| Tapioca Starch | 7½% | 7½ | g |
| Inulin | 7½% | 7½ | g |
| Salt | 4% | 4 | g |
| TOTAL | 100% | 100 g | |

Sample E

| | | | |
|---|---|---|---|
| Garlic Purée | 81% | 81 | g |
| Tapioca Starch | 5% | 5 | g |
| Inulin | 10% | 10 | g |
| Salt | 4% | 4 | g |
| TOTAL | 100% | 100 | g |

Once made, the samples were tested. The protocol is as follows:

A. Set stove burner on medium heat.

B. Spray fry pan with Pam®.

C. Add samples to fry pan.

D. Set fry pan on burner and evaluate how the samples react to the heat.

Results:

Sample A—This sample separated and reacted very good with the heat.

Sample B—This sample turned to paste. It was very sticky because of the starch.

Sample C—This sample acted the same as B.

Sample D—This sample worked as good as sample B. This sample is very sticky.

Sample E—This sample worked as good as sample A. It separated as it heated. This sample had 5% starch.

### Example 20

The samples from Example 18 were tested to determine the presence of liquid separation.

Methodology:

1. The bottom of circular plastic cup (diameter=3.81 cm and height=1.90 cm) was traced on the middle of a flat coffee filter with a #2 pencil. A flat iron set at very low heat was used to flatten the coffee filter.

2. 20 grams of thawed garlic purée was weighed into the plastic cup. The cup was tapped several times to even out the sample.

3. The coffee filter was positioned on top of the cup with the traced circle matching the rim.

4. The cup and coffee filter were inverted immediately onto a flat cookie sheet.

5. The inverted plastic cup was allowed to sit on top of the coffee filter for 5 minutes.

6. The extent of the liquid flow was marked at 8 equidistant points around the traced circle.

7. The distance from each point on the traced circle to each marked point of the liquid flow was measured in millimeters

8. The average of all 8 measurements was taken and reported as the average distance of liquid flow.

9. Two tests were performed for each sample.

Results and Discussion

Summary of Results

| | Distance of Liquid Flow (mm) | | |
|---|---|---|---|
| | Test 1 | Test 2 | Ave. |
| A- 81% Garlic Purée + 15% Inulin + | 0 mm | 0 mm | 0 mm |
| 4% Salt | | | |
| B- 70% Garlic Purée + 30% High | 6.19 mm | 7.88 mm | 7.03 mm |
| Fructose CS | | | |
| C- 100% Garlic Purée | 8.31 mm | 5.00 mm | 6.65 mm |

In sample A, there was no liquid mark on the coffee filter beyond the traced circle when the sample with inulin was tested. In fact very little liquid mark was on the inner traced circle. The results indicated that there was liquid separation in both the fructose formulation and the 100% garlic purée but not in the inulin formulation.

Thus, there has been shown and described a soft frozen purée which fulfills all the objects and advantages sought therefor. It is apparent to those skilled in the art, however, that many changes, variations, modifications, and other uses and applications to the soft frozen purée are possible, and also such changes, variations, modifications, and other uses and applications which do not depart from the spirit and scope of the invention are deemed to be covered by the invention, which is limited only by the claims which follow.

What is claimed is:

1. A soft frozen purée composition, comprising:
(a) plant material;
(b) a carbohydrate water binder; and,
(c) salt.

2. The composition of claim 1, wherein the carbohydrate water binder is selected from the group consisting of disaccharides, oligosaccharides, fructans, native starch, unmodified flour, polyhydric alcohol, and starch hydrolysis products.

3. The composition of claim 1, wherein the plant material is selected from the group consisting of: vegetables, fruits, spices, and herbs.

4. The composition of claim 1, wherein the plant material is added to the purée composition in an amount ranging between 60% and 90% by weight of the purée composition.

5. The composition of claim 1, wherein the carbohydrate water binder is added to the purée composition in an amount ranging between 5% and 25% by weight of the purée composition.

6. The composition of claim 1, wherein the salt selected from the group consisting of sodium chloride, potassium chloride, calcium phosphates, sodium citrates, potassium citrates, and calcium citrates is added to the purée composition in an amount ranging between 0.1% and 10% by weight of the purée composition.

7. The composition of claim 1 wherein the purée comprises a food grade acid selected from a group consisting of phosphoric, tartaric, malic, citric, adipic, fumaric, gluconic and similar food grade acidulants, is added to the purée composition in an amount ranging between 0.1 to 5.0% by weight of the purée composition.

8. The composition of claim 2, wherein the fructan is inulin.

9. A soft frozen purée composition, comprising:
(a) plant material added in an amount ranging between 60% and 90% by weight of the purée composition; and,
(b) a carbohydrate water binder added in an amount ranging between 2% and 25% by weight of the purée composition.

10. The composition of claim 9, wherein the carbohydrate water binder is selected from the group consisting of disaccharides, oligosaccharides, fructans, native starch, unmodified flour, polyhydric alcohol, and starch hydrolysis products.

11. The composition of claim 9, wherein a food grade acid selected from a group consisting of phosphoric, tartaric, malic, citric, adipic, fumaric, gluconic and similar food grade acidulants, is added to the purée composition in amount ranging between 0.1 to 5.0% by weight of the purée composition.

12. The composition of claim 9, wherein a second carbohydrate water binder is added in an amount ranging between 5% and 25% by weight of the purée.

13. The composition of claim 9, wherein a third carbohydrate water binder is added in an amount ranging between 0.1% and 10% by weight of the purée.

14. The composition of claim 9, wherein the carbohydrate water binder is added in an amount ranging between 5% and 20% by weight of the purée composition.

15. The composition of claim 9, wherein a salt is added, the salt is selected from the group consisting of sodium chloride, potassium chloride, calcium phosphates, sodium citrates, potassium citrates, and calcium citrates is added to the purée composition in an amount ranging between 0.1% and 10% by weight of the purée composition.

16. A soft frozen purée composition comprising:
(a) plant material added in an amount ranging between 60% and 90% by weight of the purée composition;
(b) a carbohydrate water binder added in an amount ranging between 5% and 25% by weight of the purée composition; and
(c) a second carbohydrate water binder added in an amount ranging between 5% and 25% by weight of the purée.

17. The composition of claim 16, wherein the carbohydrate water binder is selected from the group consisting of disaccharides, oligosaccharides, fructans, native starch, unmodified flour, polyhydric alcohol, and starch hydrolysis products.

18. The composition of claim 16, wherein a food grade acid selected from a group consisting of phosphoric, tartaric, malic, citric, adipic, fumaric, gluconic and similar food grade acidulants, added to the purée composition in an amount ranging between 0.1 to 5.0% by weight of the frozen purée composition.

19. The soft frozen purée of claim 16, wherein the purée has a total dextrose and fructose content ranging between 0.1 % and 5% by weight of the purée.

20. The soft frozen purée of claim 16, wherein the purée has maximum stress of between 0.001 kPa and 5.000 kPa.

21. The soft frozen purée of claim 16, wherein the plant material ranges in size from purée to whole pieces.

22. The frozen purée of claim 16, whereby the product does not undergo syneresis upon thawing.

23. The frozen purée of claim 16, whereby the product does not undergo Maillard-type browning during heating.

24. A soft frozen purée composition comprising:
(a) plant material added in an amount ranging between 60% and 90% by weight of the purée composition;
(b) a carbohydrate water binder added in an amount ranging between 5% and 25% by weight of the purée composition; and
(c) a second carbohydrate water binder added in an amount ranging between 5% and 25% by weight of the purée.
(d) salt added in an amount ranging between 0.1% and 10% by weight of the purée.

25. The composition of claim 24, wherein the carbohydrate water binder is selected from the group consisting of disaccharides, oligosaccharides, fructans, native starch, unmodified flour, polyhydric alcohol, and starch hydrolysis products.

26. The composition of claim 24, wherein a food acid selected from a group consisting of phosphoric, tartaric, malic, citric, adipic, fumaric, gluconic and similar food grade acidulants, is added to the purée composition in an amount ranging between 0.1 to 5.0% by weight of the frozen purée composition.

27. A soft frozen purée composition comprising:
(a) plant material added in an amount ranging between 60% and 90% by weight of the purée composition;
(b) a carbohydrate water binder added in an amount ranging between 5% and 25% by weight of the purée composition; and
(c) a second carbohydrate water binder added in an amount ranging between 5% and 25% by weight of the purée.
(d) a third carbohydrate water binder added in an amount ranging between 0.1% and 10% by weight of the purée.

28. The composition of claim 27, wherein the carbohydrate water binder is selected from the group consisting of disaccharides, oligosaccharides, fructans, native starch, unmodified flour, polyhydric alcohol, and starch hydrolysis products.

29. The composition of claim 27, wherein a food acid selected from a group consisting of phosphoric, tartaric, malic, citric, adipic, fumaric, gluconic and similar food grade acidulants is added to the purée composition in an amount ranging between 0.1 to 5.0% by weight of the frozen purée composition.

30. A method for forming a soft frozen purée, comprising:
(a) obtaining plant material;
(b) puréeing the plant material to form a plant purée;
(c) mixing an amount of at least one carbohydrate water binder with the plant purée to form a soft purée; and,
(d) freezing the soft purée to form the soft frozen purée.

31. The method of claim 30, wherein the method comprises blanching the plant material.

32. The method of claim 30, wherein the method comprises adding an amount of salt to the soft purée.

33. The method of claim 30, wherein the method comprises adding an amount of acid to the soft purée.

34. The method of claim 30, wherein the method comprises a treating step selected from the group consisting of roasting, sautéing, frying or grilling the purée.

35. The method of claim 30, wherein a second carbohydrate water binder is mixed with the purée.

36. The method of claim 30, wherein the plant material is added to the purée composition in an amount ranging between 60% and 90% by weight of the purée composition.

37. The method of claim 30, wherein the carbohydrate water binder is added to the purée composition in an amount ranging between 5% and 25% by weight of the purée composition.

38. A frozen purée composition, comprising:
(a) plant material; and,
(b) inulin.

39. An unfrozen purée composition, comprising:
(a) room temperature plant material; and,
(b) room temperature carbohydrate water binder.
